(19) United States
(12) Patent Application Publication
(10) Pub. No.: US 2018/0237057 A1
(43) Pub. Date: Aug. 23, 2018

(54) ELECTRIC POWER STEERING DEVICE

(71) Applicants: Mitsuba Corporation, Gunma (JP); Shindengen Electric Manufacturing Co., Ltd., Tokyo (JP)

(72) Inventors: Hiroaki Tanikawa, Kiryu-shi (JP); Shuichi Matsuhashi, Kiryu-shi (JP); Toru Furusawa, Kiryu-shi (JP); Tamotsu Iwazaki, Kiryu-shi (JP)

(21) Appl. No.: 15/754,843

(22) PCT Filed: Sep. 29, 2016
(86) PCT No.: PCT/JP2016/078841

§ 371 Date: Feb. 23, 2018

(30) Foreign Application Priority Data
Sep. 30, 2015 (JP) 2015-192652

(51) Int. Cl. B62D 5/04

(52) U.S. Cl. CPC B62D 5/0475; B62D 5/0463

(57) ABSTRACT

An electric power steering device includes an electric motor driven by electric power from a power supply and configured to apply an assisting force to a steering shaft, a booster circuit connected to the power supply and configured to supply a boosting voltage to the electric motor, and a boosting control unit configured to determine a starting condition under which the start of boosting of the booster circuit is controlled on the basis of an angular acceleration of the electric motor, and start the boosting of the booster circuit when the determined starting condition is satisfied.

### TECHNICAL FIELD

The present invention relates to an electric power steering device. Priority is claimed on Japanese Patent Application No. 2015-192652, filed Sep. 30, 2015, the content of which is incorporated herein by reference.

### TECHNICAL BACKGROUND

In the related art, there is known an electric power steering device configured to detect a steering torque applied to a steering handle by a driver or the like using a steering torque sensor, and generate a steering assist force according to the detected steering torque using a motor to apply the steering assist force to the steering handle. In recent times, an electric power steering device capable of obtaining a larger steering assist force by boosting a voltage of a battery using a booster circuit and supplying the boosted voltage to a motor driving circuit has been proposed (for example, see Patent Literature 1).

In such a device, when boosting is normally performed by a booster circuit in order to increase a voltage of a battery such that a steering assist force is not insufficient, the booster circuit is increased in size. Further, switching loss is normally generated on the basis of a switching operation of a transistor that constitutes the booster circuit. As a result, energy loss in the booster circuit becomes relatively large. Patent Literature 1 discloses an electric power steering device configured to boost a voltage of a battery using a booster circuit only when a duty ratio of a pulse width modulation (PWM) signal of turning on/off a switching element of a motor driving circuit exceeds a predetermined threshold (100%).

### RELATED ART DOCUMENTS

### Patent Document

### Patent Document 1

Japanese Patent Application, Publication No. 2003-200845

### SUMMARY OF INVENTION

### Technical Problem

Here, in the electric power steering device disclosed in Patent Literature 1, boosting of a battery voltage is performed when a duty ratio of a PWM signal on the basis of a deviation between a target current value set based on the steering torque and a detected value of current flowing through the electric motor exceeds 100% that is previously set. For this reason, time may be required for the duty ratio of the PWM signal to exceed 100%. Accordingly, when a driver abruptly turns the steering handle, a duty ratio of a PWM signal may not reach a predetermined threshold even though a steering assist force is required in actuality. That is, in the electric power steering device disclosed in Patent Document 1, when a voltage of the battery cannot be boosted at a desired timing, a driver feels uncomfortable with the steering feeling due to a time lag until the voltage is boosted in actuality.

An object of the present invention is to provide an electric power steering device capable of reducing a driver's discomfort with regard to steering feeling even when the driver abruptly turns a steering handle.

### Solution to Problem

An aspect of the present invention is an electric power steering device including: an electric motor driven by electric power from a power supply and configured to apply an assisting force to a steering shaft; a booster circuit connected to the power supply and configured to supply a boosting voltage to the electric motor; and a boosting control unit configured to determine a starting condition under which the start of boosting of the booster circuit is controlled on the basis of an angular acceleration of the electric motor, and starts the boosting of the booster circuit when the determined starting condition is satisfied.

In addition, in the above-mentioned electric power steering device of the aspect of the present invention, the boosting control unit determines the starting condition on the basis of the angular acceleration and a rotational speed of the electric motor.

In addition, in the above-mentioned electric power steering device of the aspect of the present invention, the boosting control unit determines the starting condition on the basis of the angular acceleration of the electric motor and a vehicle speed of the vehicle.

In addition, in the above-mentioned electric power steering device of the aspect of the present invention, the boosting control unit further determines a stoppage condition under which boosting of the booster circuit is stopped on the basis of the angular acceleration of the electric motor when the booster circuit boosts a voltage of the power supply, and stops the boosting of the booster circuit when the determined stoppage condition is satisfied.

In addition, in the above-mentioned electric power steering device of the aspect of the present invention, the starting condition and the stoppage condition have hysteresis widths.

### Advantageous Effects of Invention

As described above, according to the present invention, it is possible to provide an electric power steering device capable of reducing a driver's discomfort with respect to steering feeling even when a steering handle is abruptly turned.

### BRIEF DESCRIPTION OF THE DRAWINGS

FIG. 1 is a view showing an example of a schematic configuration of an electric power steering device according to a first embodiment.

FIG. 2 is a view showing an example of a schematic configuration of a control device according to the first embodiment.

FIG. 3 is a view showing an example of a schematic configuration of a motor driving unit according to the first embodiment.

FIG. 4 is a view showing an example of a schematic configuration of an electric power steering device according to a second embodiment.

FIG. 5 is a view showing an example of a schematic configuration of a control device according to the second embodiment.

FIG. 6 is a view showing an example of a schematic configuration of an electric power steering device according to a third embodiment.

FIG. 7 is a view showing an example of a schematic configuration of a control device according to the third embodiment.

### DESCRIPTION OF EMBODIMENTS

Hereinafter, the present invention will be described through an embodiment of the present invention, but the following embodiment does not restrict the present invention according to the claims. In addition, not all combinations of features described in the embodiment are necessarily essential to the solutions of the present invention. Further, in the drawings, the same or similar parts are designated by the same reference numerals, and overlapping description thereof may be omitted. In addition, shapes, sizes, and so on of elements in the drawings may be exaggerated to more clearly describe the embodiment.

An electric power steering device (an electric power steering (EPS) system) according to the embodiment drives an electric motor using electric power supplied from a power supply on the basis of a detected value of a torque sensor configured to detect a steering torque of a steering handle of a vehicle, and applies a steering assisting force (an assisting force) to the steering shaft. Then, the electric power steering device according to the embodiment includes a booster circuit configured to boost a voltage of a power supply, and a boosting control unit configured to determine a starting condition of controlling the beginning of boosting of the booster circuit on the basis of an angular acceleration of the electric motor and start boosting of the booster circuit when the determined starting condition is established. Hereinafter, the electric power steering device according to the embodiment will be described with reference to the accompanying drawings.

### First Embodiment

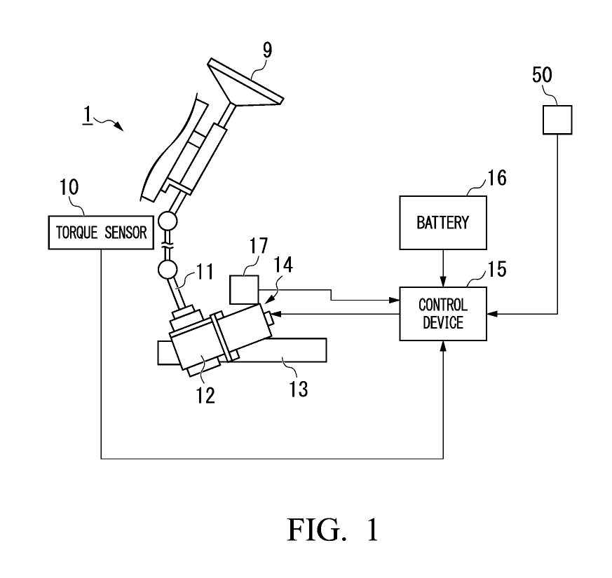

FIG. 1 is a view showing an example of a schematic configuration of an electric power steering device 1 according to a first embodiment. As shown in FIG. 1, the electric power steering device 1 includes a steering handle 9, a torque sensor 10, a steering shaft 11, a gearbox 12, a steering mechanism 13, an electric motor 14, a control device (a controller) 15, a battery 16, a rotation angle detecting unit 17 and a vehicle speed sensor 50.

The steering handle 9 is connected to the steering shaft 11. One end of the steering shaft 11 is connected to the steering handle 9 and the other end is connected to the gearbox 12. The steering shaft 11 generates a steering torque F applied between the gearbox 12 and the steering shaft 11 when the steering handle 9 is operated by a driver. The steering shaft 11 rotates according to the steering torque F. The torque sensor 10 is a sensor configured to detect the steering torque F generated in the steering shaft 11 and is constituted by, for example, a torsion bar type twisting force detecting sensor. The torque sensor 10 outputs the detected steering torque F to the control device 15.

The steering mechanism 13 is connected to the gearbox 12. The steering mechanism 13 steers front wheels (not shown) of a vehicle according to an operating force and a steering torque F of the steering handle for a driver transmitted via the gearbox 12.

The electric motor 14 is connected to the gearbox 12. The electric motor 14 is electrically connected to the control device 15. The electric motor 14 is driven by a driving signal from the control device 15. The electric motor 14 assists a steering force that the steering mechanism 13 steers the front wheels of the vehicle. That is, rotation of the electric motor 14 is transmitted to the steering shaft 11 via the gearbox 12. Accordingly, an operation of the steering mechanism 13 is assisted, and a driver's labor burden for steering is reduced. Hereinafter, in the embodiment, the case in which the electric motor 14 is a brushless motor of 3 phases (U, V and W) will be described.

The rotation angle detecting unit 17 includes the electric motor 14. The rotation angle detecting unit 17 detects a rotation angle of a rotor of the electric motor 14. For example, the rotation angle detecting unit 17 is a magnetic rotary encoder including a resolver or a Hall IC. The rotation angle detecting unit 17 outputs an output signal according to the detected rotation angle to the control device 15.

The control device 15 includes a circuit (a processor, a CPU, circuitry), and is electrically connected to the battery 16 (the power supply) mounted on the vehicle. The control device 15 controls driving of the electric motor 14 such that current flowing through the electric motor 14 becomes a target value. In addition, the control device 15 applies a steering assisting force that assists a steering force of the steering mechanism 13 to the steering shaft 11 by controlling driving of the electric motor 14 on the basis of the steering torque F detected by the torque sensor 10.

The vehicle speed sensor 50 measures a vehicle speed E of the vehicle on which the electric power steering device 1 is mounted. The vehicle speed sensor 50 supplies the measured vehicle speed E to the control device 15.

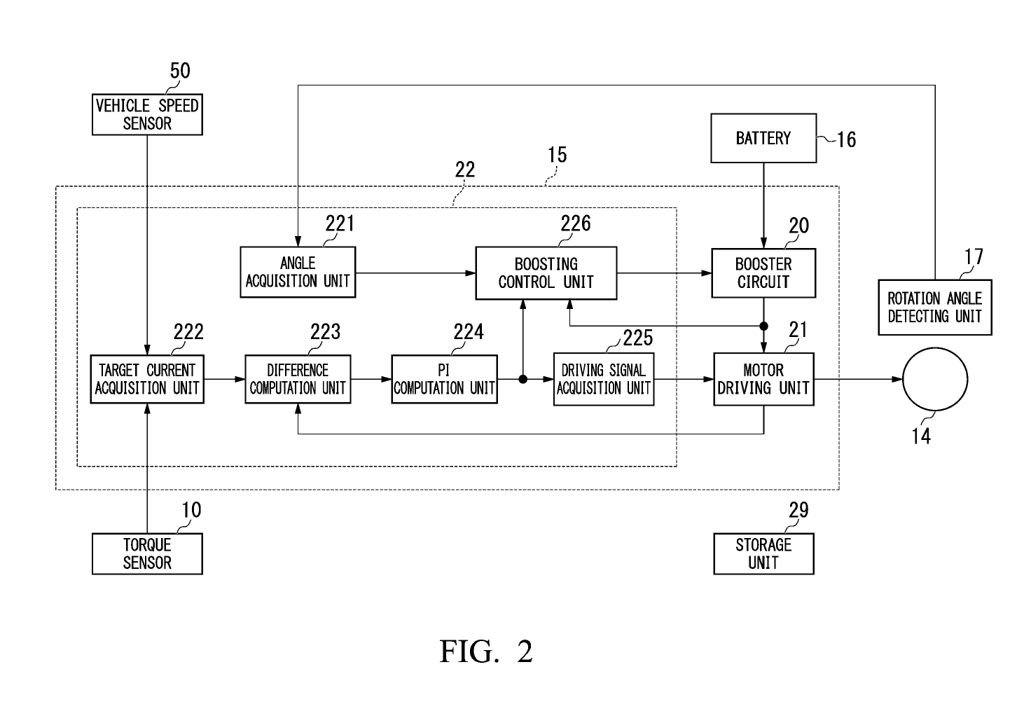

FIG. 2 is a view showing an example of a schematic configuration of the control device 15 according to the first embodiment. As shown in FIG. 2, the control device 15 includes a booster circuit 20, a motor driving unit 21 and a control unit (a circuit (a processor, a CPU, circuitry)) 22.

The booster circuit 20 is connected to the battery (the power supply) 16 and the motor driving unit 21, and a voltage from the battery 16 (hereinafter referred to as “a battery voltage”) V_{b} is supplied. The booster circuit 20 boosts the battery voltage V_{b} on the basis of a booster circuit driving signal supplied from the control unit 22, and supplies the boosted voltage (hereinafter, referred to as “a boosting voltage”) Vₛ to the motor driving unit 21. However, the booster circuit 20 does not boost the battery voltage V_{b} when the booster circuit driving signal from the control unit 22 is not supplied. Accordingly, the booster circuit 20 supplies the battery voltage V_{b} to the motor driving unit 21 as it is when the booster circuit driving signal from the control unit 22 is not supplied.

The motor driving unit 21 applies the voltage supplied from the booster circuit 20 to the electric motor 14 on the basis of the driving signal supplied from the control unit 22. For example, the motor driving unit 21 is an inverter circuit including a plurality of switching elements. The motor driving unit 21 drives the following switching elements through pulse width modulation (PWM) and applies a predetermined driving voltage to the electric motor 14 to drive the electric motor 14 on the basis of the driving signal supplied from the control unit 22.

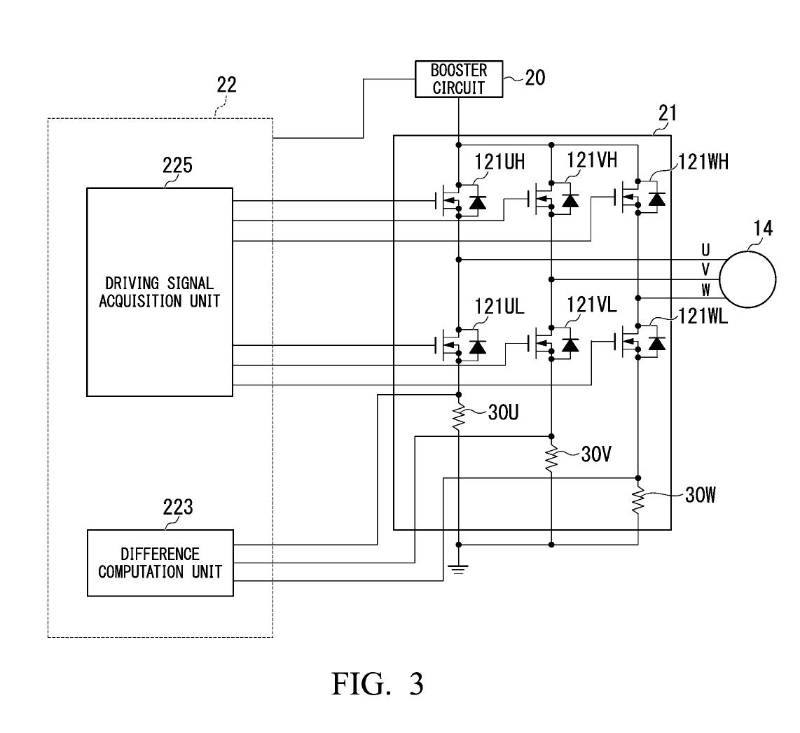

FIG. 3 is a view showing an example of a schematic configuration of the motor driving unit 21 according to the embodiment. As shown in FIG. 3, the motor driving unit 21 converts a direct current voltage supplied from the booster circuit 20 into an alternating current voltage and applies the converted alternating current voltage to the electric motor 14. The direct current voltage supplied from the booster circuit 20 is the battery voltage V_{b} or the boosting voltage Vₛ.

The motor driving unit 21 includes six switching elements 121UH, 121UL, 121VH, 121VL, 121WH and 121WL. The motor driving unit 21 switches ON and OFF of the switching elements 121UH to 121WL to convert a direct current voltage into an alternating current voltage.

The switching elements 121UH and 121UL that are connected in series, the switching elements 121VH and 121VL that are connected in series, and the switching elements 121WH and 121WL that are connected in series are connected to each other in parallel between the elements and the ground potential via current measurement units 30U, 30V and 30W. In addition, a connecting point of the switching elements 121UH and 121UL is connected to one end of a coil U. A connecting point of the switching elements 121VH and 121VL and a connecting point of the switching elements 121WH and 121WL are connected to one end of a coil V and one end of a coil W, respectively.

Each of the switching elements 121UH to 121WL has a configuration in which, for example, a field effect transistor (FET), an insulated gate bipolar transistor (IGBT), or the like is connected to a circulation diode in parallel. Further, in the embodiment, the case in which the FET is used will be described, and a parasitic diode in the FET has a function of the circulation diode. In addition, each of the switching elements 121UH to 121WL switches ON and OFF on the basis of the driving signal input from the control unit 22.

The current measurement units 30U, 30V and 30W are connected to the switching elements 121UH and 121UL, the switching elements 121VH and 121VL and the switching elements 121WH and 121WL between the units and the ground levels thereof in the motor driving unit 21. For example, the current measurement units 30U, 30V and 30W are constituted by shunt resistors. The current measurement units 30U, 30V and 30W measure a current value flowing through the motor driving unit 21, i.e., a current value Iₘ input to the electric motor 14. The current measurement units 30U, 30V and 30W output the measured current value Iₘ to the control unit 22. Further, while the case in which the current measurement units 30U, 30V and 30W are the shunt resistors has been described in the embodiment, the present invention is not limited thereto.

Returning to FIG. 2, the control unit 22 includes an angle acquisition unit 221, a target current acquisition unit 222, a difference computation unit 223, a PI computation unit 224, a driving signal acquisition unit 225 and a boosting control unit 226.

The angle acquisition unit 221 acquires an angular acceleration A of the electric motor 14 on the basis of the rotation angle supplied from the rotation angle detecting unit 17. For example, the angle acquisition unit 221 acquires an output signal according to the rotation angle supplied from the rotation angle detecting unit 17. The angle acquisition unit 221 detects a variation amount per unit time of an output signal showing a rotation angle supplied from the rotation angle detecting unit 17, and calculates a rotational speed N of the electric motor 14 (a rotor of the electric motor 14) from the detected variation amount. An angular velocity ω of the electric motor 14 is obtained by the rotational speed N. The angle acquisition unit 221 calculates the angular acceleration A of the electric motor 14 on the basis of the variation amount per unit time of the calculated rotational speed N. The angle acquisition unit 221 supplies the calculated angular acceleration A to the boosting control unit 226.

The target current acquisition unit 222 acquires a target value (hereinafter, referred to as “a target current value”) Iₜ of the motor current flowing through the electric motor 14 on the basis of the vehicle speed E of the vehicle measured by the vehicle speed sensor 50 and the steering torque F supplied from the torque sensor 10. The target current acquisition unit 222 supplies the acquired target current value Iₜ to the difference computation unit 223. The target current acquisition unit 222 may acquire the target current value Iₜ on the basis of, for example, a previously set calculation equation or table. The calculation equation or the table may be determined experimentally or theoretically such that the target current value Iₜ of the electric motor 14 can be determined on the basis of, for example, the vehicle speed E and the steering torque F. The target current acquisition unit 222 may previously store a look-up table including vehicle speeds, steering torques F, and the target current values Iₜ of the related motor current whenever the vehicle speed E and the steering torque F are combined in a storage unit (a memory) 29 when a preset table is used. Then, the target current acquisition unit 222 acquires the vehicle speed E supplied from the torque sensor 10 and the target current value Iₜ corresponding to the steering torque F from the look-up table, and supplies the obtained target current value Iₜ to the difference computation unit 223.

The difference computation unit 223 acquires the target current value Iₜ from the target current acquisition unit 222. The difference computation unit 223 acquires the current value Iₘ measured by the current measurement units 30U, 30V and 30W of the motor driving unit 21. The difference computation unit 223 acquires a difference value ΔI (=target current value Iₜ−current value Iₘ) by subtracting the current value Iₘ obtained from the motor driving unit 21 from the target current value Iₜ supplied from the target current acquisition unit 222. The difference computation unit 223 supplies the acquired difference value ΔI to the PI computation unit 224.

The PI computation unit 224 performs proportional (P) control processing and integral (I) control processing (hereinafter referred to as “PI control”) with respect to the difference value ΔI supplied from the difference computation unit 223, and computes a command value V_{d} that brings the difference value ΔI close to a predetermined value, for example, 0. For example, the command value V_{d} is a voltage value applied to the electric motor 14. The PI computation unit 224 supplies the computed command value V_{d} to the boosting control unit 226 and the driving signal acquisition unit 225. However, in the embodiment, the control is not limited to the PI control, and PID control may be performed or other feedback control may be performed.

The driving signal acquisition unit 225 converts the command value V_{d} supplied from the PI computation unit 224 into a driving signal constituted by pulses that ON/OFF drive the switching elements of the motor driving unit 21 through pulse width modulation (PWM), i.e., a pulse width modulation signal. The driving signal acquisition unit 225 supplies the converted driving signal to the motor driving unit 21.

The boosting control unit 226 estimates high speed rotation of the electric motor 14 by an increase of the angular acceleration A of the electric motor 14, and determines a timing when an operation of the booster circuit 20 starts. In addition, the boosting control unit 226 estimates low speed rotation of the electric motor 14 by a decrease of the angular acceleration A of the electric motor 14, and determines a timing when an operation of the booster circuit 20 stops. That is, the boosting control unit 226 controls driving of the booster circuit 20 on the basis of the angular acceleration A of the electric motor 14. The case in which the electric motor 14 is rotated at a high speed corresponds to the case in which the steering handle 9 is greatly turned in a short time by a driver. That is, the case in which the electric motor 14 is rotated at a high speed corresponds to the case in which the steering assisting force is immediately required. For example, in the case, it is estimated that the steering handle is abruptly turned by the driver in the vehicle during traveling. Accordingly, the boosting control unit 226 can immediately apply the steering assisting force to the steering shaft 11 by immediately starting the boosting of the booster circuit 20 when it is estimated that the electric motor 14 is rotated at a high speed on the basis of the angular acceleration A of the electric motor 14. The boosting control unit 226 acquires a value of the boosting voltage Vₛ supplied from the booster circuit 20 to the motor driving unit 21, and controls the booster circuit 20 such that the acquired boosting voltage Vₛ becomes a desired voltage.

Hereinafter, processing of the boosting control unit 226 according to the first embodiment will be described in detail.

The boosting control unit 226 determines a control condition under which boosting of the booster circuit 20 is controlled on the basis of the angular acceleration A supplied from the angle acquisition unit 221. The control condition includes a first starting condition and a first stoppage condition. The first starting condition is a condition under which a timing at which the boosting of the battery voltage V_{b} is started by the booster circuit 20 is controlled. The first stoppage condition is a condition under which a timing at which the boosting of the battery voltage V_{b} is stopped by the booster circuit 20 is controlled. Accordingly, the first starting condition is a condition used when the boosting of the battery voltage V_{b} is not performed by the booster circuit 20. Meanwhile, the first stoppage condition is a condition used when the boosting of the battery voltage V_{b} is performed by the booster circuit 20.

The first starting condition varies according to the angular acceleration A supplied from the angle acquisition unit 221 in real time. For example, a first starting map including angular accelerations of the electric motors 14 and the first starting condition related to each angular acceleration is previously stored in a storage unit 29 (or an external storage unit 29) in the boosting control unit 226. Then, the boosting control unit 226 determines the first starting condition corresponding to the angular acceleration A supplied from the angle acquisition unit 221 by acquiring the first starting condition from the first starting map. The boosting control unit 226 supplies a booster circuit driving signal to the booster circuit 20 when the command value V_{d} supplied from the PI computation unit 224 corresponds to the first starting condition. Further, the case in which the command value V_{d} corresponds to the first starting condition corresponds to a case in which the first starting condition is satisfied. In addition, the first starting condition is set such that a condition range becomes wider as the angular acceleration A is increased. That is, the first starting condition is set such that the command value V_{d} corresponding to the first starting condition is increased as the angular acceleration A is increased. Accordingly, since the command value V_{d} corresponding to the first starting condition is increased as the angular acceleration A is increased, boosting of the booster circuit 20 is started earlier.

The first stoppage condition varies according to the angular acceleration A supplied from the angle acquisition unit 221 in real time. For example, a first stoppage map including angular accelerations of the electric motors 14 and a first stoppage condition related to each of the angular accelerations is previously stored in the storage unit 29 (or an external storage unit 29) in the boosting control unit 226. Then, the boosting control unit 226 determines the first stoppage condition corresponding to the angular acceleration A supplied from the angle acquisition unit 221 through acquisition from the first stoppage map. The boosting control unit 226 stops supply of a booster circuit driving signal to the booster circuit 20 when the command value V_{d} supplied from the PI computation unit 224 corresponds to the first stoppage condition. The case in which the command value V_{d} corresponds to the first stoppage condition is defined as that the first stoppage condition is satisfied. In addition, the first stoppage condition is set such that a condition range becomes wider as the angular acceleration A is decreased. That is, the first stoppage condition is set such that the command value V_{d} corresponding to the first stoppage condition is increased as the angular acceleration A is decreased. Accordingly, since the command value V_{d} corresponding to the first starting condition is increased as the angular acceleration A is decreased, boosting of the booster circuit 20 is stopped earlier.

As described above, the electric power steering device 1 according to the embodiment determines a first starting condition under which the start of the boosting of the booster circuit 20 is controlled on the basis of the angular acceleration of the electric motor 14, and starts the boosting of the booster circuit 20 when the determined first starting condition is satisfied. Accordingly, since a voltage of the battery can be boosted at a desired timing, a driver's discomfort with regard to steering feeling can be decreased. That is, boosting control with no delay in assisting the steering force becomes possible.

In addition, the electric power steering device 1 according to the above-mentioned embodiment further determines a first stoppage condition under which boosting of the booster circuit 20 is stopped on the basis of the angular acceleration of the electric motor 14 when the booster circuit 20 boosts the battery voltage V_{b}, and stops the boosting of the booster circuit 20 when the determined first stoppage condition is satisfied. Accordingly, since the boosting of the voltage of the battery can be stopped at a desired timing, a driver's discomfort with regard to steering feeling can be reduced.

### Second Embodiment

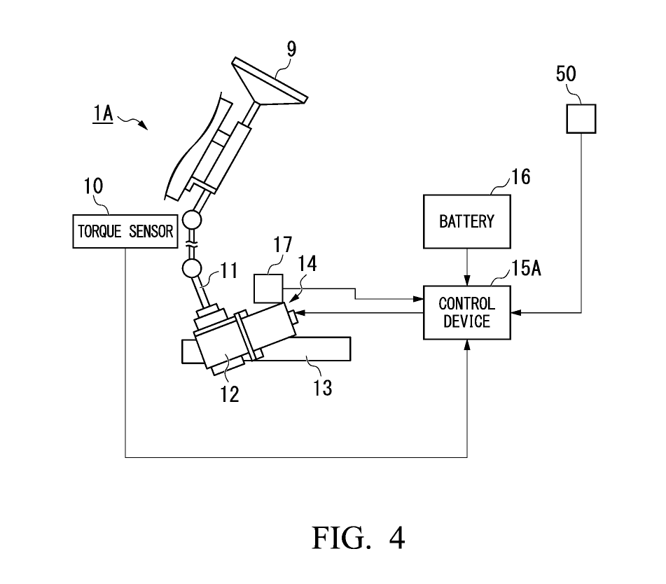

FIG. 4 is a view showing an example of a schematic configuration of an electric power steering device 1A according to a second embodiment. As shown in FIG. 4, the electric power steering device 1A includes a steering handle 9, a torque sensor 10, a steering shaft 11, a gearbox 12, a steering mechanism 13, an electric motor 14, a control device 15A, a battery 16, a rotation angle detecting unit 17 and a vehicle speed sensor 50.

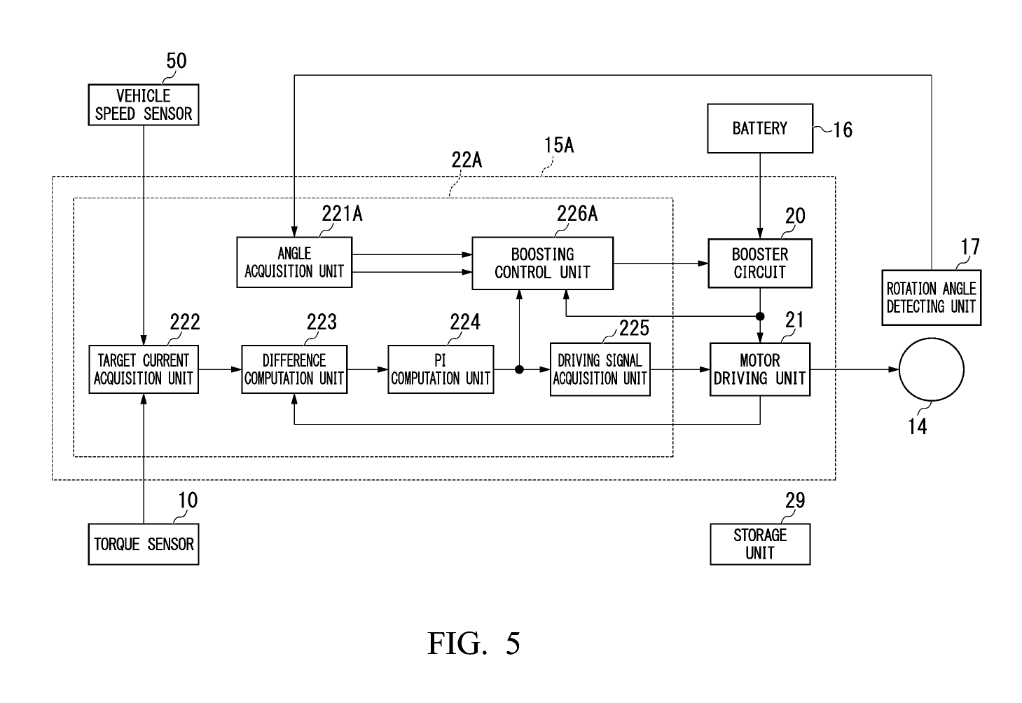

FIG. 5 is a view showing an example of a schematic configuration of the control device 15A according to the second embodiment. The control device 15A includes a booster circuit 20, a motor driving unit 21 and a control unit 22A. The control unit 22A includes an angle acquisition unit 221A, a target current acquisition unit 222, a difference computation unit 223, a PI computation unit 224, a driving signal acquisition unit 225 and a boosting control unit 226A.

The angle acquisition unit 221A acquires a rotational speed N and an angular acceleration A of the electric motor 14 on the basis of the rotation angle supplied from the rotation angle detecting unit 17. For example, the angle acquisition unit 221A acquires an output signal according to the rotation angle supplied from the rotation angle detecting unit 17. The angle acquisition unit 221A detects a variation amount per unit time of an output signal showing a rotation angle supplied from the rotation angle detecting unit 17, and calculates the rotational speed N of the electric motor 14 (a rotor of the electric motor 14) from the detected variation amount. An angular velocity ω of the electric motor 14 is obtained by the rotational speed N. The angle acquisition unit 221A calculates the angular acceleration A of the electric motor 14 on the basis of the variation amount per unit time of the calculated the rotational speed N. The angle acquisition unit 221A supplies the calculated rotational speed N and the angular acceleration A to the boosting control unit 226A.

The boosting control unit 226A estimates high speed rotation of the electric motor 14 by an increase in the angular acceleration A and the rotational speed N of the electric motor 14, and determines a timing when an operation of the booster circuit 20 starts. In addition, the boosting control unit 226A estimates low speed rotation of the electric motor 14 by a decrease in the angular acceleration A and the rotational speed N of the electric motor 14, and determines a timing when the operation of the booster circuit 20 stops. That is, the boosting control unit 226A controls driving of the booster circuit 20 on the basis of the angular acceleration A and the rotational speed N of the electric motor 14. In the second embodiment, when the electric motor 14 is rotated at a high speed, the steering handle 9 may be largely turned in a short time by a driver. That is, when the electric motor 14 is rotated at a high speed, a steering assisting force may be urgently needed, and for example, it is assumed that the steering handle is abruptly turned by a driver in the vehicle during traveling. Accordingly, the boosting control unit 226A can immediately apply the steering assisting force to the steering shaft 11 by immediately starting the boosting of the booster circuit 20 when it is estimated that the electric motor 14 is rotated at a high speed on the basis of the angular acceleration A and the rotational speed N of the electric motor 14. The boosting control unit 226A acquires a value of the boosting voltage Vₛ supplied from the booster circuit 20 to the motor driving unit 21, and controls the booster circuit 20 such that the acquired boosting voltage Vₛ becomes a desired voltage.

Hereinafter, processing of the boosting control unit 226A in the second embodiment will be described in detail.

The boosting control unit 226A determines a control condition under which boosting of the booster circuit 20 is controlled on the basis of the angular acceleration A and the rotational speed N supplied from the angle acquisition unit 221A. The control condition includes a second starting condition and a second stoppage condition.

The second starting condition is changed according to the angular acceleration A and the rotational speed N supplied from the angle acquisition unit 221A in real time. For example, a second starting map including angular accelerations of the electric motors 14, rotational speeds of the electric motors 14, and second starting conditions related to combinations of the angular accelerations and the rotational speeds of the electric motors 14 is previously stored in the storage unit 29 (or an external storage unit 29) in the boosting control unit 226A. Then, the boosting control unit 226A determines the second starting condition corresponding to the combination of the angular acceleration A and the rotational speed N supplied from the angle acquisition unit 221A through acquisition from the second starting map. The boosting control unit 226A supplies a booster circuit driving signal to the booster circuit 20 when the command value V_{d} supplied from the PI computation unit 224 corresponds to the second starting condition. Further, when the command value V_{d} corresponds to the second starting condition, the second starting condition is said to be satisfied. In addition, the second starting condition is set such that a range of the condition value is widened as values of the angular acceleration A and the rotational speed N are increased. That is, the second starting condition is set such that the command value V_{d} corresponding to the second starting condition is increased as the values of the angular acceleration A and the rotational speed N are increased. Accordingly, since the command value corresponding to the second starting condition is increased as the values of the angular acceleration A and the rotational speed N are increased, boosting of the booster circuit 20 is started earlier.

The second stoppage condition is changed according to the angular acceleration A and the rotational speed N supplied from the angle acquisition unit 221A in real time. For example, a second stoppage map including angular accelerations of the electric motors 14, rotational speeds of the electric motors 14, and second stoppage conditions related to combinations of the angular accelerations and the rotational speeds of the electric motor 14 is previously stored in the storage unit 29 (or an external storage unit 29) in the boosting control unit 226A. Then, the boosting control unit 226A determines the second stoppage condition corresponding to the combination of the angular acceleration A and the rotational speed N supplied from the angle acquisition unit 221A through acquisition from the second stoppage map. The boosting control unit 226A stops supply of the booster circuit driving signal to the booster circuit 20 when the command value V_{d} supplied from the PI computation unit 224 corresponds to the second stoppage condition. Further, when the command value V_{d} corresponds to the second stoppage condition, the second stoppage condition is said to be satisfied. In addition, the second stoppage condition is set such that a range of the condition value is widened as values of the angular acceleration A and the rotational speed N are decreased. That is, the second stoppage condition is set such that the command value V_{d} corresponding to the second stoppage condition is increased as the values of the angular acceleration A and the rotational speed N are decreased. Accordingly, since the command value V_{d} corresponding to the second stoppage condition is increased as the values of the angular acceleration A and the rotational speed N are decreased, boosting of the booster circuit 20 is stopped earlier.

As described above, the electric power steering device 1A according to the second embodiment determines the second starting condition under which the start of the boosting of the booster circuit 20 is controlled on the basis of the angular acceleration of the electric motor 14, and starts the boosting of the booster circuit 20 when the determined second starting condition is satisfied. Accordingly, since the voltage of the battery can be boosted at a desired timing, a driver's discomfort with regard to steering feeling can be reduced. That is, boosting control with no delay in assisting the steering force becomes possible. In addition, the second starting condition is determined on the basis of the angular acceleration and the rotational speed of the electric motor 14. Accordingly, the electric power steering device 1A can more accurately estimate high speed rotation than in the first embodiment.

In addition, the electric power steering device 1A according to the above-mentioned second embodiment further determines a second stoppage condition under which boosting of the booster circuit 20 is stopped on the basis of the angular acceleration of the electric motor 14 when the booster circuit 20 boosts the battery voltage V_{b}, and stops the boosting of the booster circuit 20 when the determined second stoppage condition is satisfied. Accordingly, since the boosting of the voltage of the battery can be stopped at a desired timing, a driver's discomfort with regard to steering feeling can be reduced.

### Third Embodiment

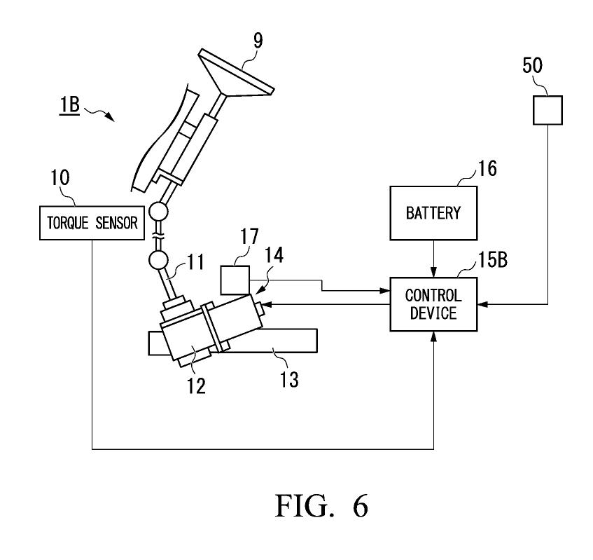

FIG. 6 is a view showing an example of a schematic configuration of an electric power steering device 1B according to a third embodiment. As shown in FIG. 6, the electric power steering device 1B includes a steering handle 9, a torque sensor 10, a steering shaft 11, a gearbox 12, a steering mechanism 13, an electric motor 14, a control device 15B, a battery 16, a rotation angle detecting unit 17 and a vehicle speed sensor 50.

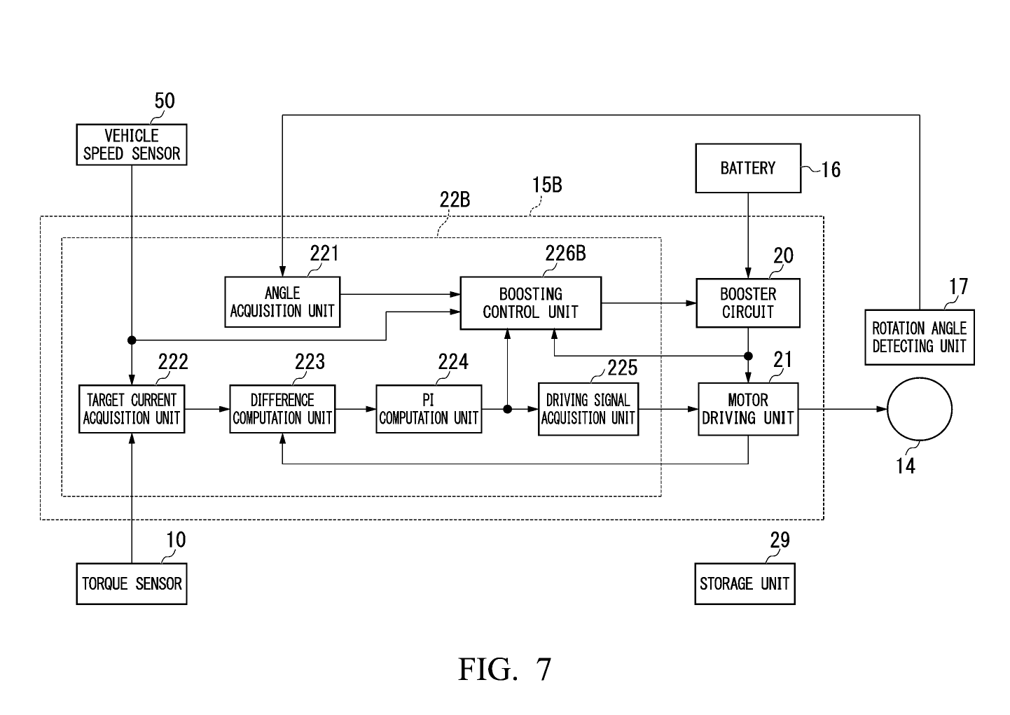

FIG. 7 is a view showing an example of a schematic configuration of the control device 15B according to the third embodiment. The control device 15B includes a booster circuit 20, a motor driving unit 21 and a control unit 22B. The control unit 22B includes an angle acquisition unit 221, a target current acquisition unit 222, a difference computation unit 223, a PI computation unit 224, a driving signal acquisition unit 225 and a boosting control unit 226B.

The boosting control unit 226B acquires a vehicle speed E measured by the vehicle speed sensor 50 and an angular acceleration A of the electric motor 14 acquired by the angle acquisition unit 221. The boosting control unit 226B estimates high speed rotation of the electric motor 14 by an increase in an angular acceleration A and a vehicle speed E, and determines a timing when an operation of the booster circuit 20 starts. In addition, the boosting control unit 226B estimates low speed rotation of the electric motor 14 by a decrease in the angular acceleration A and the vehicle speed E, and determines a timing when the operation of the booster circuit 20 stops. That is, the boosting control unit 226B controls driving of the booster circuit 20 on the basis of the angular acceleration A and the vehicle speed E. In the third embodiment, when the electric motor 14 is rotated at a high speed, the steering handle 9 may be largely turned in a short amount of time by a driver. That is, when the electric motor 14 is rotated at a high speed, a steering assisting force may be urgently needed, and for example, it is assumed that the steering handle is abruptly turned by a driver in the vehicle during traveling. Accordingly, the boosting control unit 226B can immediately apply the steering assisting force to the steering shaft 11 by starting the boosting of the booster circuit 20 when it is estimated that the electric motor 14 is rotated at a high speed on the basis of the angular acceleration A and the vehicle speed E. The boosting control unit 226B acquires a value of the boosting voltage Vₛ supplied from the booster circuit 20 to the motor driving unit 21, and controls the booster circuit 20 such that the acquired boosting voltage Vₛ becomes a desired voltage.

Hereinafter, processing of the boosting control unit 226B according to the third embodiment will be described in detail.

The boosting control unit 226B determines a control condition under which boosting of the booster circuit 20 is controlled on the basis of the angular acceleration A and the vehicle speed E supplied from the angle acquisition unit 221. The control condition includes a third starting condition and a third stoppage condition.

The third starting condition is changed according to the angular acceleration A and the vehicle speed E supplied from the angle acquisition unit 221 in real time. For example, a third starting map including angular accelerations of the electric motors 14, rotational speeds of the electric motors 14, and third starting conditions related to combinations of the angular acceleration and the rotational speeds of the electric motor 14 is previously stored in the storage unit 29 (or an external storage unit 29) in the boosting control unit 226B. Then, the boosting control unit 226B determines the third starting condition corresponding to the combination of the angular acceleration A and the vehicle speed E supplied from the angle acquisition unit 221 through acquisition from the third starting map. The boosting control unit 226B supplies a booster circuit driving signal to the booster circuit 20 when the command value V_{d} supplied from the PI computation unit 224 corresponds to the third starting condition. Further, when the command value V_{d} corresponds to the third starting condition, the third starting condition is said to be satisfied. In addition, the third starting condition is set such that a range of the condition is widened as values of the angular acceleration A and the vehicle speed E are increased. That is, the third starting condition is set such that the command value V_{d} corresponding to the third starting condition is increased as the values of the angular acceleration A and the vehicle speed E are increased. Accordingly, since the command value corresponding to the third starting condition is increased as the values of the angular acceleration A and the vehicle speed E are increased, boosting of the booster circuit 20 is started earlier.

The third stoppage condition is changed according to the angular acceleration A and the vehicle speed E supplied from the angle acquisition unit 221 in real time. For example, a third stoppage map including angular accelerations of the electric motors 14, rotational speeds of the electric motors 14, and third stoppage conditions related to combinations of the angular accelerations and the rotational speeds of the electric motor 14 is previously stored in the storage unit 29 (or an external storage unit 29) in the boosting control unit 226B. Then, the boosting control unit 226B determines the third stoppage condition corresponding to the combination of the angular acceleration A and the vehicle speed E supplied from the angle acquisition unit 221 through acquisition from the third stoppage map. The boosting control unit 226B stops supply of the booster circuit driving signal to the booster circuit 20 when the command value V_{d} supplied from the PI computation unit 224 corresponds to the third stoppage condition. Further, when the command value V_{d} corresponds to the third stoppage condition, the third stoppage condition is said to be satisfied. In addition, the third stoppage condition is set such that a range of the condition value is widened as values of the angular acceleration A and the vehicle speed E are decreased. That is, the third stoppage condition is set such that the command value V_{d} corresponding to the third stoppage condition is increased as the values of the angular acceleration A and the vehicle speed E are decreased. Accordingly, since the command value V_{d} corresponding to the third stoppage condition is increased as the values of the angular acceleration A and the vehicle speed E are decreased, boosting of the booster circuit 20 is stopped earlier.

As described above, the electric power steering device 1B according to the third embodiment determines the third starting condition under which the start of the boosting of the booster circuit 20 is controlled on the basis of the angular acceleration of the electric motor 14, and starts the boosting of the booster circuit 20 when the determined third starting condition is satisfied. Accordingly, since the voltage of the battery can be boosted at a desired timing, a driver's discomfort with regard to steering feeling can be reduced. That is, boosting control with no delay in assisting the steering force becomes possible. In addition, the third starting condition is determined on the basis of the angular acceleration and the vehicle speed of the electric motor 14. Accordingly, the electric power steering device 1B can more accurately estimate high speed rotation than in the first embodiment.

In addition, the electric power steering device 1B according to the above-mentioned third embodiment further determines a third stoppage condition under which boosting of the booster circuit 20 is stopped on the basis of the angular acceleration of the electric motor 14 when the booster circuit 20 boosts the battery voltage V_{b}, and stops the boosting of the booster circuit 20 when the determined third stoppage condition is satisfied. Accordingly, since the boosting of the voltage of the battery can be stopped at a desired timing, a driver's discomfort with regard to steering feeling can be reduced.

In the above-mentioned embodiment, the starting conditions (the first to third starting conditions) and the stoppage conditions (the first to third stoppage conditions) may include hysteresis widths. That is, a range of the stoppage condition is narrower than that of the starting condition. Accordingly, since occurrence of repetition (chattering) of boosting and non-boosting of the booster circuit 20 in a short time can be suppressed as the command value V_{d} is changed, a driver's discomfort with regard to steering feeling can be further reduced.

In addition, in the above-mentioned embodiment, the starting condition and the stoppage condition may be the same condition. That is, the case in which the starting condition is not satisfied may be a condition in which the stoppage condition is satisfied.

Parts of the control unit 22 may be realized by hardware or may be realized by a combination of hardware and software. In addition, a computer may function as a part of the control unit 22 by executing a program. The program may be stored in a computer-readable medium, or may be stored in a storage device connected to a network.

The boosting control units 226, 226A and 226B according to the above-mentioned embodiments may be realized by a computer. In this case, a program configured to perform a function thereof may be recorded on a computer-readable recording medium, and the program recorded on the recording medium may be read and executed by a computer system. Further, “computer system” disclosed herein includes hardware such as an OS, peripheral devices, or the like. In addition, “computer-readable recording medium” refers to a portable storage medium such as a flexible disk, an opto-magnetic disc, a ROM, a CD-ROM, or the like, or a storage device such as a hard disk or the like installed in a computer system. Further, “computer-readable recording medium” may include a medium for dynamically holding a program for a short amount of time, such as a communication channel when a program is transmitted via a network such as the Internet or the like or a communication line such as a telephone line or the like, and a medium of holding a program for a certain time such as a volatile memory in a computer system that is a server or a client in this case. In addition, the program may be configured to realize some of the above-mentioned functions, may be configured to further realize a combination of the above-mentioned functions and the program previously recorded on the computer system, and may be realized using a programmable logic device such as a field programmable gate array (FPGA) or the like.

While embodiments of the present invention have been described above in detail with reference to the accompanying drawings, the specific configuration is not limited to the embodiments and may include designs or the like without departing from the spirit of the present invention.

An execution sequence of processing of operations, procedures, steps and stages of devices, systems, programs and methods in the claims, the specification and the drawings may be realized in an arbitrary sequence unless words such as “before,” “previously,” and the like are particularly used, and as long as an output of the foregoing processing is not used in the following processing. In operation flows of the claims, even when the specification and the drawings are described using words such as “first,” “next,” or the like, it does not mean that the operation flows are necessarily performed in this sequence.

### EXPLANATION OF NUMERALS AND CHARACTERS

1 Electric power steering device

9 Steering handle

10 Torque sensor

11 Steering shaft

12 Gearbox

13 Steering mechanism

14 Electric motor

15 Control device

16 Battery

20 Booster circuit

21 Motor driving unit

22 Control unit

50 Vehicle speed sensor

221 Angle acquisition unit

222 Target current acquisition unit

223 Difference computation unit

224 PI computation unit

225 Driving signal acquisition unit

226 Boosting control unit

1. An electric power steering device comprising:
an electric motor driven by electric power from a power supply and configured to apply an assisting force to a steering shaft;
a booster circuit connected to the power supply and configured to supply a boosting voltage to the electric motor; and
a boosting control unit configured to determine a starting condition under which the start of boosting of the booster circuit is controlled on the basis of an angular acceleration of the electric motor, and start the boosting of the booster circuit when the determined starting condition is satisfied.

2. The electric power steering device according to claim 1, wherein the boosting control unit determines the starting condition on the basis of the angular acceleration and a rotational speed of the electric motor.

3. The electric power steering device according to claim 1, wherein the boosting control unit determines the starting condition on the basis of the angular acceleration of the electric motor and a vehicle speed of the vehicle.

4. The electric power steering device according to claim 1, wherein the boosting control unit further determines a stoppage condition under which boosting of the booster circuit is stopped on the basis of the angular acceleration of the electric motor when the booster circuit boosts a voltage of the power supply, and stops the boosting of the booster circuit when the determined stoppage condition is satisfied.

5. The electric power steering device according to claim 4, wherein the starting condition and the stoppage condition have hysteresis widths.
